(19) United States
(12) Patent Application Publication
(10) Pub. No.: US 2006/0010055 A1
(43) Pub. Date: Jan. 12, 2006

(54) Business evaluation supporting method

(76) Inventors: Mayumi Morita, Yokohama (JP); Tomohiro Umezawa, Yokohama (JP); Osamu Kubo, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/975,401

(22) Filed: Oct. 29, 2004

(30) Foreign Application Priority Data
Jun. 21, 2004 (JP) 2004-181984

(51) Int. Cl. G06Q 40/00

(52) U.S. Cl. 705/35

(57) ABSTRACT

A method and an apparatus for easily and efficiently setting an evaluation index suitable for an evaluation purpose when a business or a business portfolio is evaluated. In the method and apparatus, investment distribution is easily and visually confirmed during computation of the evaluation index when an object to be computed is the business portfolio. A table for defining a computation expression model for the evaluation index and a correspondence relationship between the evaluation index and the evaluation purpose is managed by a database to extract and provide an evaluation index model conforming to the evaluation purpose specified by a user. When the business portfolio is evaluated, business investment distributions are represented by a pie chart. The investment distribution information is updated and the evaluation index is computed, by adjusting a distribution surface of the represented pie chart.

### INCORPORATION BY REFERENCE

The present application claims priority from Japanese application JP 2004-181984 filed on Jun. 21, 2004, the content of which is hereby incorporated by reference into this application.

### BACKGROUND OF THE INVENTION

The present invention relates to a method for quantitatively calculating the value of a business or business portfolio using an evaluation index and to a program for causing a computer to process the method.

In investing in a business, attention has been focused in these years on the quantitative evaluation of business value and several examples of an apparatus for quantitatively evaluating businesses have been developed, one of which is disclosed in U.S. Patent Application Publication No. US2002/0174049.

### SUMMARY OF THE INVENTION

Even in any of these known examples, however, we cannot find any function of enabling setting of evaluation indexes according to the background or purpose of business evaluation, and the examples have problems with flexible and suitable setting/calculation of evaluation indexes. In US2002/0174049, for example, specific (fixed) evaluation indexes can be provided and only the specific indexes can be calculated. There exists an apparatus wherein an evaluation index for evaluation and a computation expression therefore are defined by the user himself. However, this apparatus requires the user to have reasonable knowledge and understanding of a relationship between the business evaluation purpose and the evaluation index as well as the computation expression of the evaluation index. For this reason, if the user has substantially no economic and business administration knowledge, then it becomes difficult for the user to operate the apparatus without being assisted by a man of great intellect and wide learning.

In US2002/0174049, for example, the apparatus has a function of evaluating not only individual businesses but also the entire value of the business portfolio, or has a function of introducing such a combination of the businesses as to increase the value of the entire portfolio. However, we failed to find any apparatus including the aforementioned known example which includes a means for studying an investment distributions within a specified budget while visually confirming it.

The present invention is directed to simplifying the setting operations of evaluation indexes, which have been so far difficult and complicated, and to increasing the efficiency of the setting operations. The present invention also aims at eliminating no coincidence between the background object of evaluation and the evaluation index. In evaluating the value of a business portfolio, there is provided a means for confirming and studying an investment distribution by a method having a high visibility and operability. This is for the purpose of simplifying a series of operations in evaluation of the value of business and business portfolio and increasing the efficiency of the portfolio value evaluation.

The present invention mainly includes three processors; that is, an evaluation index defining program 104, an invested capital defining program 105, and an investment distribution adjusting program 106. The evaluation index defining program 104 sets an evaluation index suitable for the evaluation purpose of a business, and redefines the set evaluation index in a computable state. The invested capital defining program 105 defines a model of an invested capital necessary for computation of a business investment distribution, and passes the defined model to the investment distribution adjusting program 106. The investment distribution adjusting program 106 displays and adjusts the business investment distribution based on the invested capital model defined by the invested capital defining program 105.

In the present invention, a computation expression model (which will be referred to as the evaluation index model, hereinafter) for a given evaluation index as well as a table (which will be referred to as the evaluation index/purpose correspondence table, hereinafter) for defining a correspondence relationship between the evaluation index and its evaluation purpose are previously prepared. And the model and the table are managed by a database 102. The database 102, which is stored in a storage 101 connected via a network, extracts the evaluation index model via the network. In this connection, the storage 101 for storing the database 102 may be provided at the inside of a terminal common to a processor 103.

The evaluation index defining program 104 first presents the evaluation purposes recorded in the evaluation index/purpose correspondence table as selections of the evaluation purpose to prompt the user to select one. On the basis of the evaluation purpose selected by the user as key information, the database searches for the evaluation index/purpose correspondence table an extracts therefrom an evaluation index name corresponding to the selected evaluation purpose. The database 102 extracts the evaluation index model therefrom with use of the extracted evaluation index name as key information, and returns the extracted model to the evaluation index defining program 104. The evaluation index defining program 104 ties data items forming the received evaluation index model to numeric data. That is, the program defines numeric data to be referred to. (The program basically refers to numeric data corresponding to a data item defined by each business or to a data item defined in business portfolio units). When completing definition of numeric data of all data of the evaluation index model to be referred to, the program shifts to the next processing (such as evaluation index computation or the like).

When an object to be evaluated is a business portfolio, the program ties each of the data items of the evaluation index model to numeric data with respect to all businesses of the portfolio. However, the need for the tying operation may be eliminated for some of the businesses depending on the situations.

In evaluation of the business portfolio, prior to the computation of the evaluation index, the display and adjustment of investment distributions within a specified budget are executed. This is executed by the invested capital defining program 105 and the investment distribution adjusting program 106.

First of all, the user enters an amount of investment budget for the entire business portfolio. A computation expression model (which will be referred to as the business-by-business invested-capital model, hereinafter) for the invested capital of each business is then defined using a data item belonging to each business.

A ratio of the invested capital of each business computed by the business-by-business invested-capital model to the invested budget amount is displayed as a distribution area of the business in the business portfolio by a pie chart (which will be referred to as the investment distribution pie chart, hereinafter). In the investment distribution pie chart, the distribution area of each business can be modified by dragging a boundary axis or dragging a corresponding slice of pie in the pie chart. When the distribution area is changed, the numeric data of data items of the business-by-business invested-capital model are updated. The updated numeric data are used as inputs to the computation when the evaluation index is computed with respect to the business portfolio after the distribution surface of each business is changed (that is, after the business investment distribution is changed).

The business-by-business invested capital is adjusted by the invested capital defining program 105 in a manner that will be explained below.

With respect to each of data items of the business-by-business invested capital model, first of all, a degree of contribution to the business-by-business invested capital, when the distribution surface of each business is adjusted, is previously defined. More specifically, the degrees of contribution of the data items of the business-by-business invested capital are displayed by a pie chart, the distribution surface corresponding to the contribution degree of each data item is changed by dragging a boundary axis or dragging a corresponding slice of pie in the pie chart, and the contribution degree is computed according to the distribution surface after the change (which pie chart will be referred to as contribution degree pie chart, hereinafter). An item having the distribution surface of the contribution degree pie chart of zero is treated as a fixed cost.

Next, a minimum adjustment width for each data item is determined on the basis of numeric data corresponding to each of data items of the invested capital model.

When the distribution surface of the investment distribution pie chart is changed, the investment distribution is updated by the investment distribution adjusting program 106 in a manner that will be explained below. It is assumed in the following description that an enlarged business means a business having an enlarged distribution surface in the investment distribution pie chart, whereas a reduced business means a business having a reduced distribution surface in the investment distribution pie chart.

For the enlarged business, the adjustment width of the business-by-business invested capital is determined by the contribution degree to the invested capital and by the minimum adjustment width of each data item. The distribution surface of the enlarged business in the investment distribution pie chart is adjusted according to the adjustment width. After the adjustment, an increase in the business-by-business invested capital of the enlarged business is computed.

The reduced business is reduced by the same money amount as the computed invested capital increase of the enlarged business or by an amount corresponding nearly to the computed amount. How much and which value of the data items of the business-by-business invested capital model are decreased is determined by the contribution degree to the invested capital and by the minimum adjustment width of each data item.

For both of the enlarged and reduced businesses, the numeric data of the data items of the invested capital model are updated, and the updated values are used as inputs for evaluation index computation.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows a system in accordance with an embodiment of the present invention;

FIG. 2 is an example of an evaluation index/purpose correspondence table in the embodiment of the present invention;

FIG. 3 is an example of an evaluation index tree to be managed by a database in the embodiment of the present invention;

FIG. 4 is a display screen view of the evaluation index tree in the embodiment of the present invention;

FIG. 5 is a flow of entire processing operations in the embodiment of the present invention;

FIG. 6 is a flow of processing operations of an evaluation index defining program 104 in the embodiment of the present invention;

FIG. 7 shows Part 1 of a flow of processing operations started with an invested capital defining program and ended in a business investment distribution adjusting program in the embodiment of the present invention;

FIG. 8 shows Part 2 of the flow of processing operations started with the invested capital defining program and ended in the business investment distribution adjusting program in the embodiment of the present invention;

FIG. 9 shows Part 3 of the flow of processing operations started with the invested capital defining program and ended in the business investment distribution adjusting program in the embodiment of the present invention;

FIG. 10 shows Part 4 of the flow of processing operations started with the invested capital defining program and ended in the business investment distribution adjusting program in the embodiment of the present invention;

FIG. 11 shows Part 5 of the flow of processing operations started with the invested capital defining program and ended in the business investment distribution adjusting program in the embodiment of the present invention; and

FIG. 12 is an example of an investment distribution adjustment screen view.

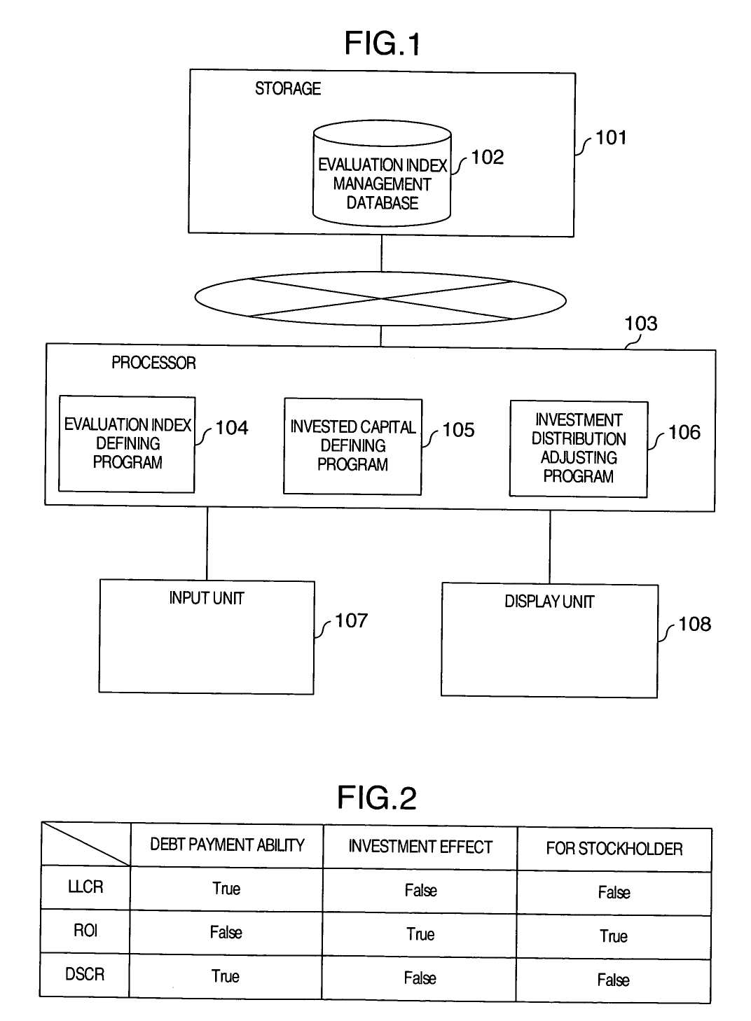

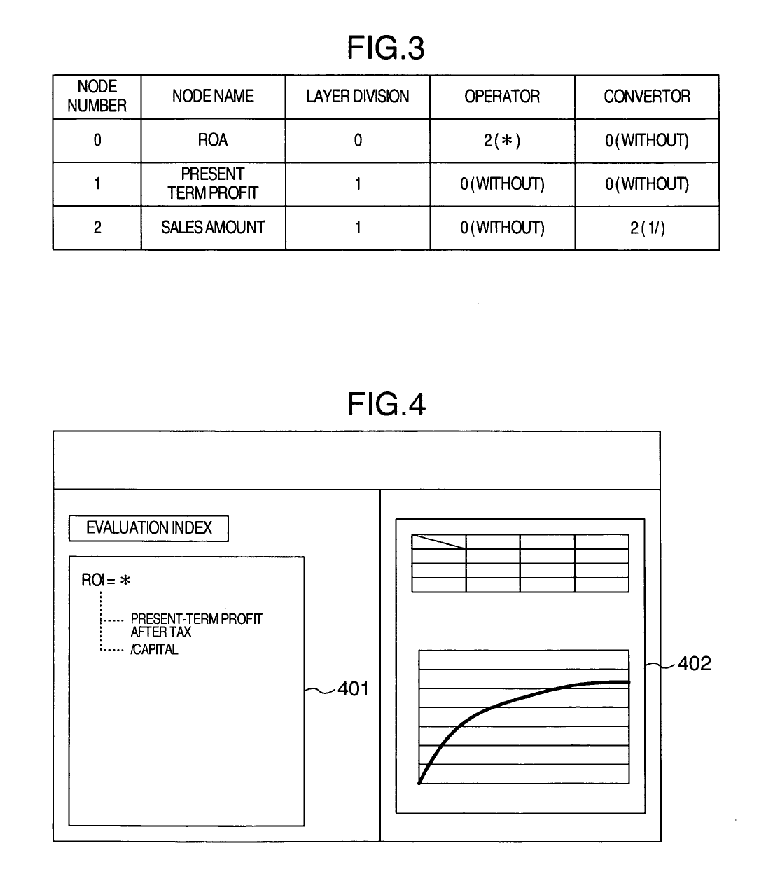

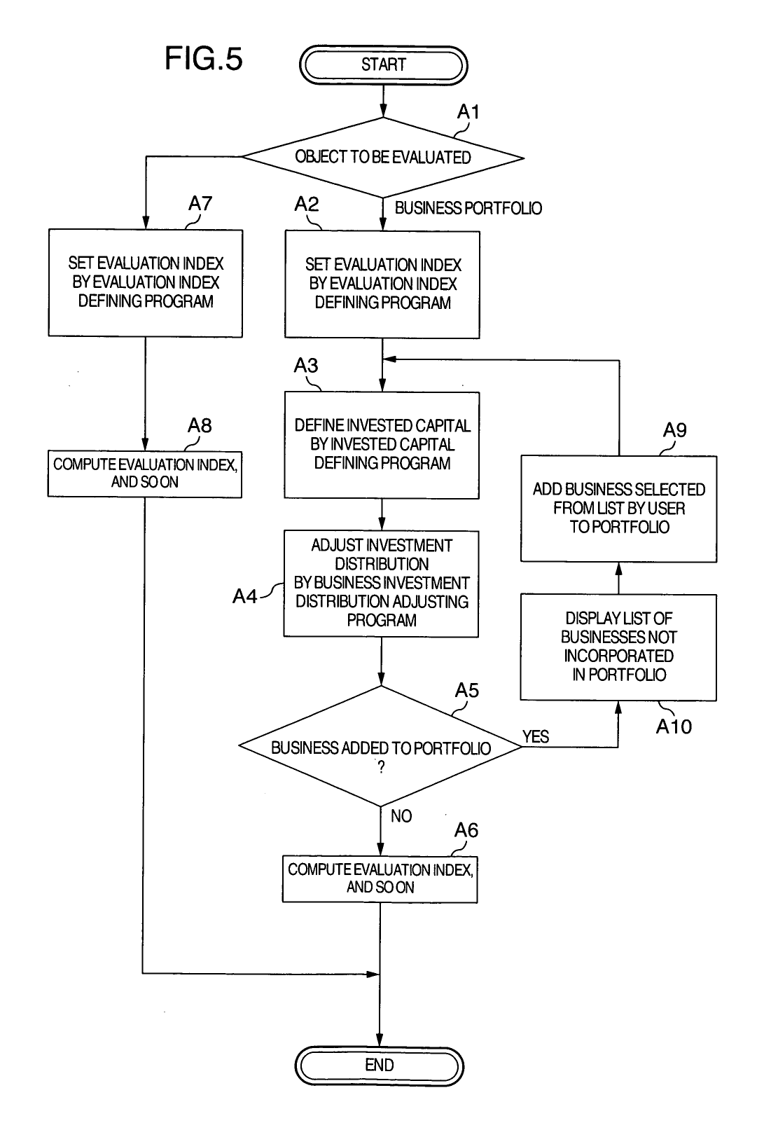

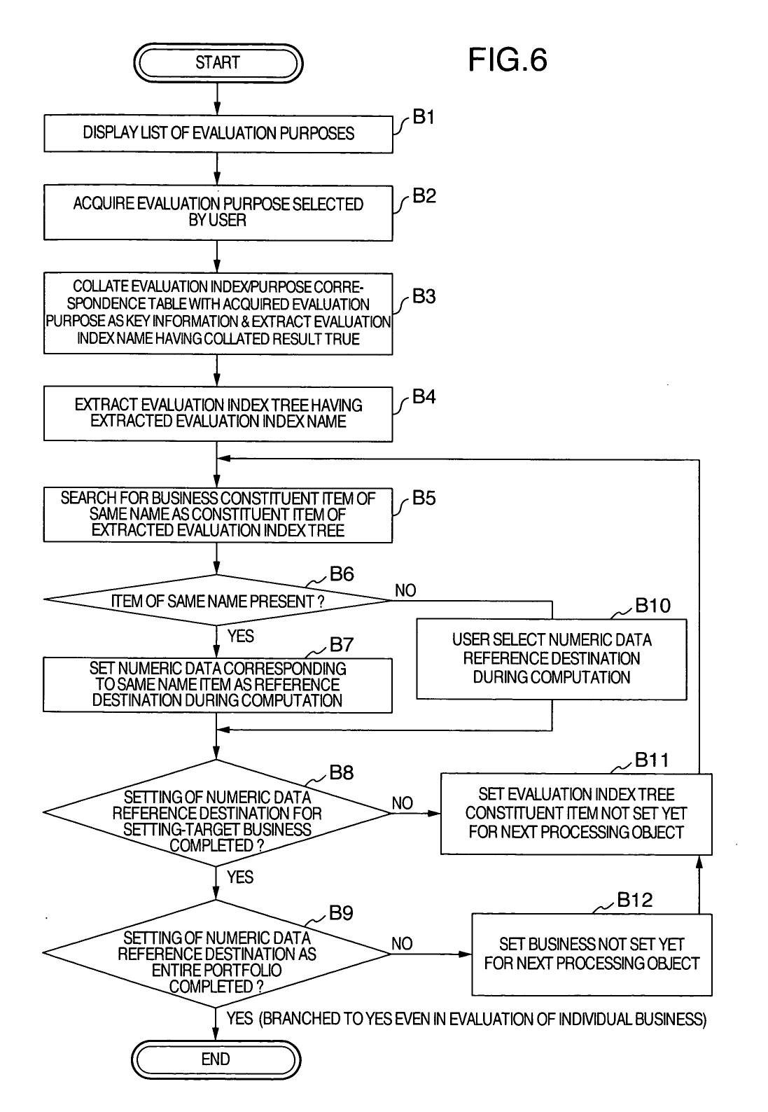

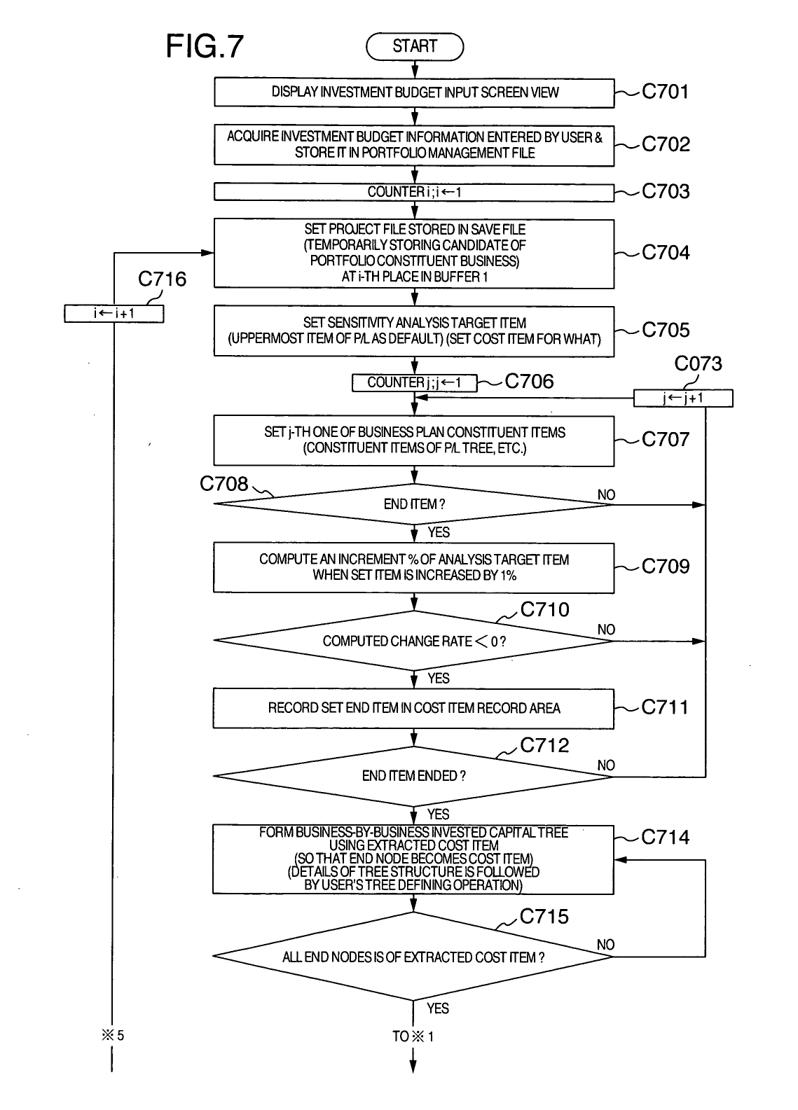

### DESCRIPTION OF THE EMBODIMENTS

A major embodiment of the present invention will be explained according to a processing procedure.

A list of evaluation purposes managed by an evaluation index/purpose correspondence table is first displayed on a display screen. The user selects at least one of the evaluation purposes in the list. This causes a corresponding evaluation index model to be extracted from a database 102 with use of the selected evaluation purpose as key information and to be returned to an evaluation index defining program 104.

The subsequent operation is branched depending upon whether an object to be evaluated is an individual business or a business portfolio.

When the object to be evaluated is an individual business, the evaluation index defining program 104 detects the presence or absence of one of data items (which will be referred to as the business constituent items, hereinafter) managed by a project file and having the same name as the data items of the received evaluation index model (which data item will be referred to as the evaluation index tree constituent items, hereinafter). The term ‘project file’ as used herein refers to a file for management of all information about businesses including data items, numeric data, etc. of each business. When the program detects a data item having the same name, the program sets numeric data corresponding to the same name business constituent item as numeric data to be referred to by the evaluation index tree constituent item during computation of the evaluation index.

When the program fails to detect the same name data item, the program causes the user to specify numeric data to be referred to during computation of the evaluation index from numeric data corresponding to the other business constituent items. In this connection, the program may cause the user to specify data managed in a region other than the project file depending on the situations.

For example, consider a case where the evaluation index model is made up of two data items of ‘present-term profit after tax’ and ‘capital’. It is also assumed that, in a project file of a business to be evaluated, only data items of ‘profit after tax’ and ‘capital’ are managed. The ‘capital’ is a data item present both in the evaluation index model and in the project file. Thus when the evaluation index is computed, numeric data of ‘capital’ in the project file is used for the computation as numeric data of ‘capital’ in the evaluation index model. Since a data item having the same name as ‘present-term profit after tax’ is not present in the project file, the user is required to specify a destination to be referred to by the numeric data. At this time, the user may specify another data item such as ‘profit after tax’ managed by the project file as a reference destination, or may specify numeric data other than the above data item as a reference destination.

After the definition of the reference destinations of the numeric data about the evaluation index tree constituent items is completed, the apparatus shifts to operations such as evaluation index computation, probability simulation, etc.

When an object to be evaluated is a business portfolio at a branch A1 for selection of the evaluation object in FIG. 5, the apparatus defines numeric data reference destinations of evaluation index tree constituent items with respect to all businesses in the business portfolio. That is, the apparatus searches for an item having the same name as the evaluation index tree constituent item for each business. When finding the same name item, the apparatus sets the found item as the reference destination of the numeric data. When failing to find the same name item, the apparatus causes the user to define the reference destination of the numeric data during the computation of the evaluation index. In this connection, the user may define data managed in a region other than the project file depending on the situations.

Next, the invested capital defining program 105 defines the contents of an invested capital in the business portfolio. The invested capital defining program 105 first displays a screen for entrance of an investment budget amount in the business to prompt the user to enter it.

When the entrance of the investment budget amount by the user is completed, an invested capital is defined for each business in a manner that will be explained below.

The invested capital defining program 105 analyzes a sensitivity of a data item. The item specified as an object for its sensitivity to be analyzed will be referred to as an analysis target item, hereinafter. The term ‘sensitivity’ as used herein refers to a rate of increase in the collected value of numeric data of the analysis target item when the numeric data of an end item (which cannot be further divided in business constituent items) forming the business is increased by 1%. An end item having a negative value of sensitivity is regarded as a cost item in the business, extracted, and displayed.

The user defines a tree-like business-by-business capital model (which will be referred to as a business-by-business invested capital tree, hereinafter). At this time, the user can define the business-by-business invested capital tree using only the extracted cost item. The cost item used for the definition of the business-by-business invested capital tree is referred to as an invested capital tree constituent item, hereinafter.

For the invested capital tree constituent items, next, the minimum adjustment width for each of the items is defined. For each end item, differences between numeric data on grids are computed and a minimum of the computed differences is previously saved in an area. For example, when a computation interval is based on year, a difference in numeric data between each year and previous year is computed except for the first year, and a minimum of the computed differences is saved. Meanwhile, a ‘minimum value/adjustment width correspondence table’ is previously prepared in a storage area such as the database 102 or a file. The ‘minimum/adjustment width correspondence table’ is a table for definition of a range of the corresponding difference minimum value. For example, when the difference minimum value is in a range of 10 to 100, the value of the minimum adjustment width is defined as 10. The difference minimum value previously saved in an area for each item is collated with the ‘minimum/adjustment width correspondence table’, and the corresponding adjustment width is set as the minimum adjustment width for the item.

A degree of contribution of the invested capital tree constituent item to the business-by-business invested capital is next determined. For the invested capital tree constituent items, a degree of contribution of each item to the analysis target item is computed, and the computed contribution degree is displayed as a distribution surface in a pie chart. The chart is referred to as a contribution degree pie chart (to the business-by-business invested capital). The distribution surface of the contribution degree may be determined and displayed using an index other than the contribution degree to the analysis target item.

The distribution surface of the contribution degree pie chart is set to be modified by dragging a boundary axis or by dragging the entire pie. In the absence of a modification, a contribution degree shown in the initial representation of the contribution degree pie chart is set as a contribution degree to the business-by-business invested capital. In the presence of a modification, the contribution degree of each item to the business-by-business invested capital is updated.

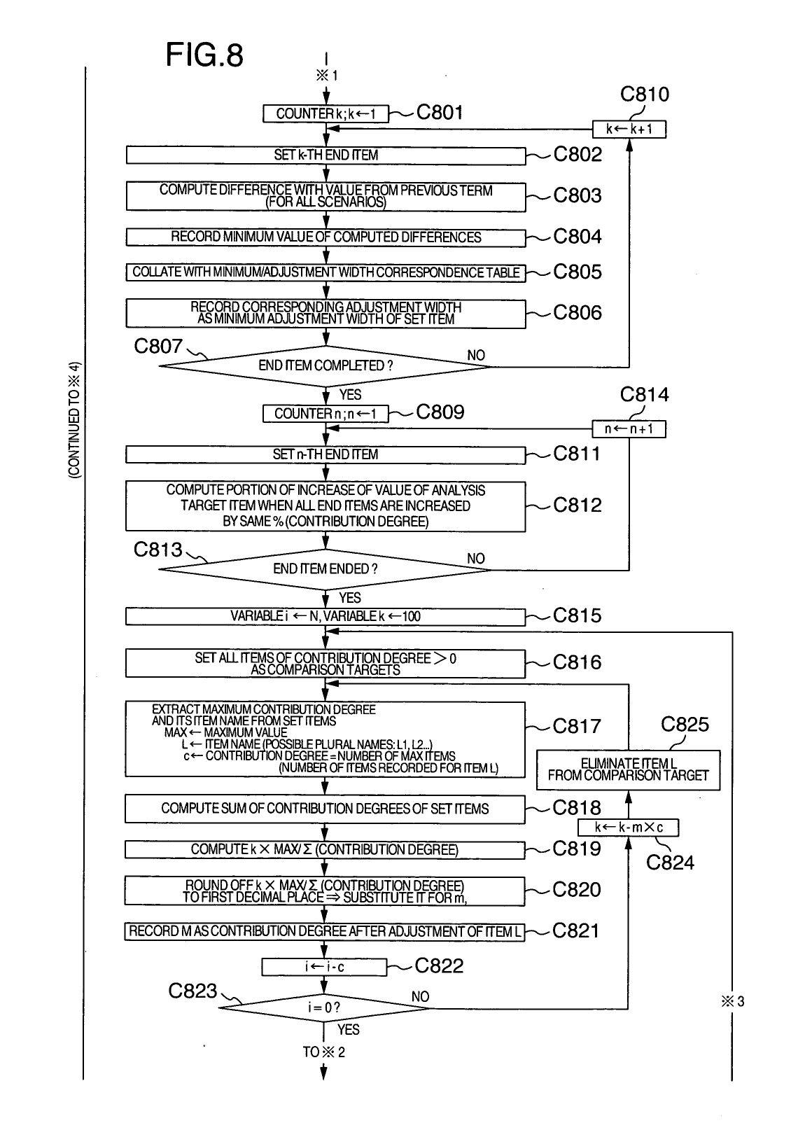

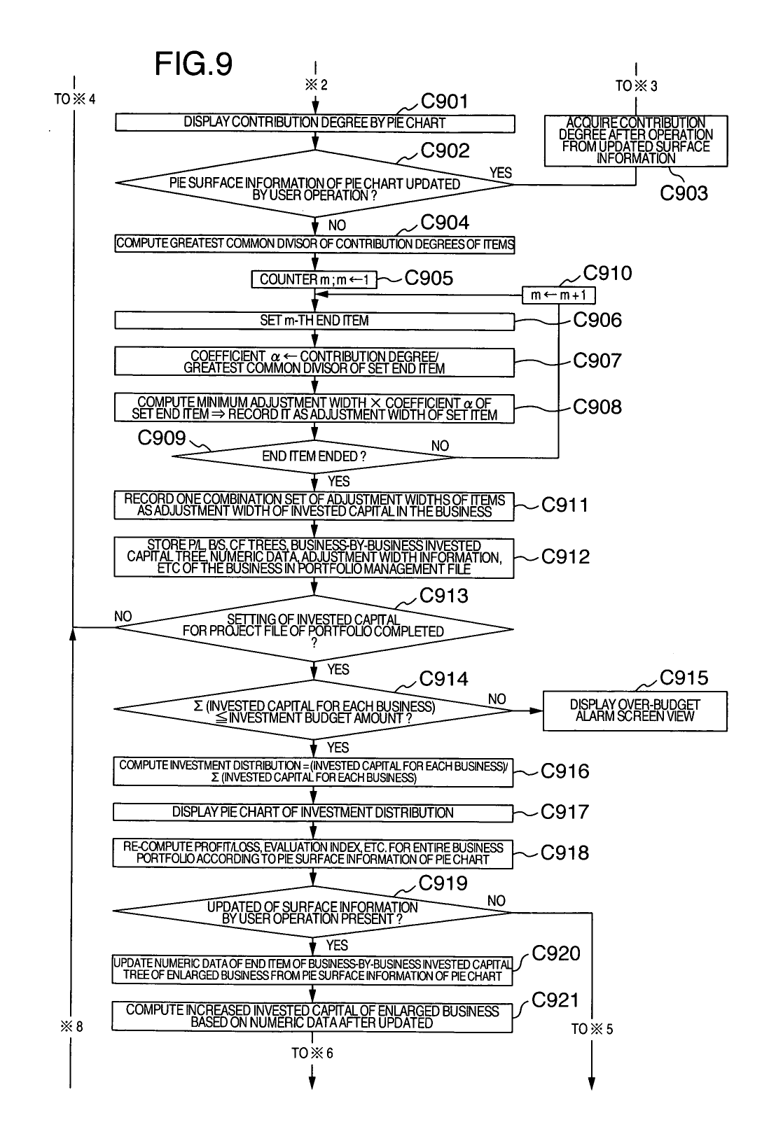

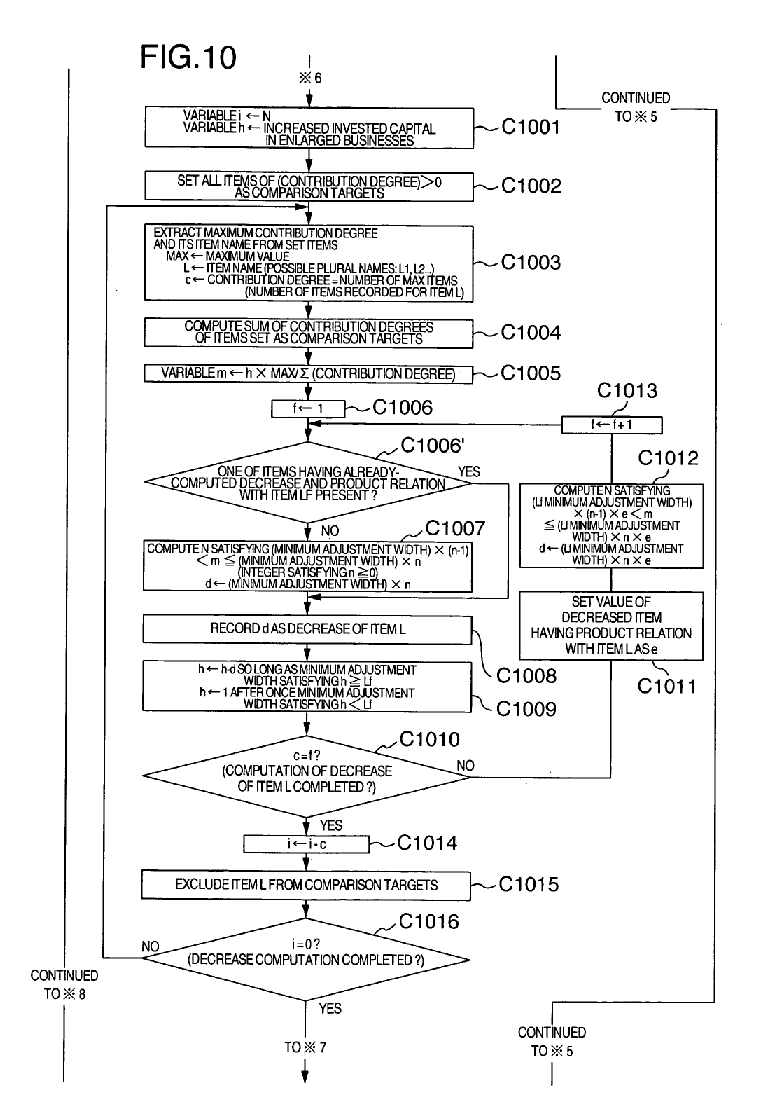

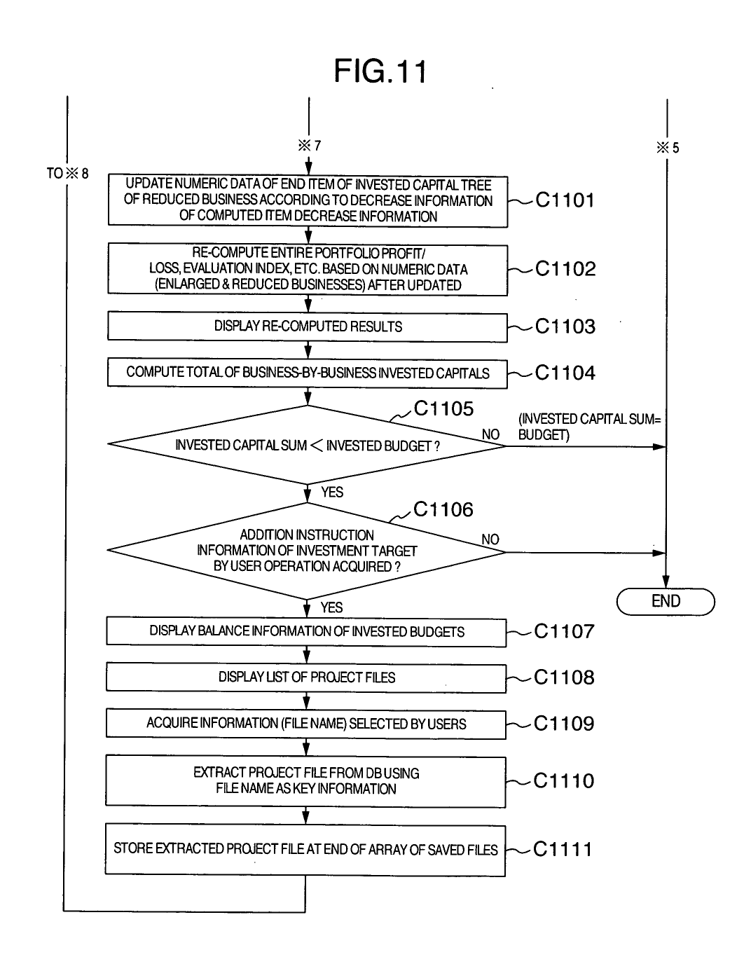

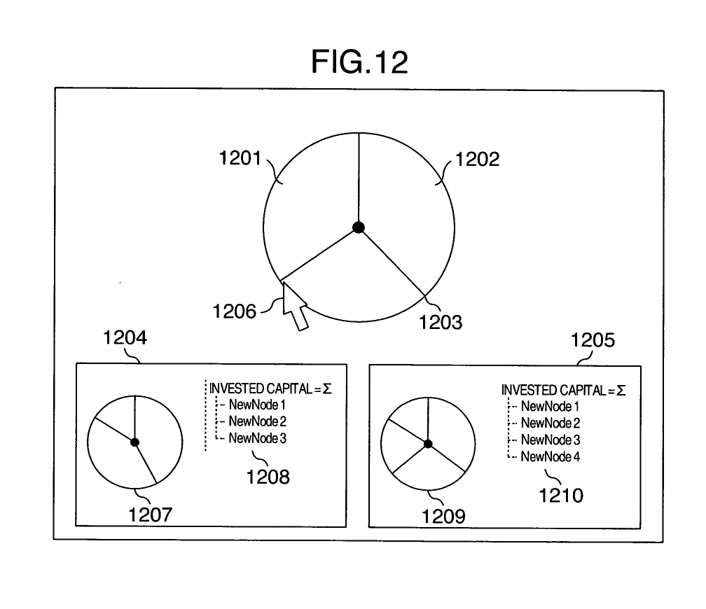

For the purpose of validating the minimum adjustment width determined through the operations of Steps C802 to C806 in FIG. 8, the contribution degree represented by the contribution degree pie chart is considered to be required to have an integer. In this case, when the computed result of the contribution degree is a decimal fraction, the fraction is converted to an integer according to a procedure of Steps C809 to C823, and then displayed in the pie chart.

First, the contribution degrees to the business-by-business invested capital between the invested capital tree constituent items are compared with respect to magnitude, and a maximum item having the maximum contribution degree is detected. A number indicative of the contribution degree of the detected item is converted to an integer by rounding off the number to the first decimal place. A value obtained by subtracting the contribution degree converted to the integer from 100% is previously saved in an area. (The value is assumed to be temporarily saved in a variable k.) An item having a second-larger contribution degree is detected.

A ratio of the integer contribution degree of the detected item to a total value of the contribution degrees of the other items not converted is computed. The computed ratio is converted to an integer by rounding off a value computed by multiplying the ratio number by the value saved in the area (variable k) to the first decimal place. The contribution degree converted to the integer is subtracted from the value saved in the area (variable k), and the area (variable k) is updated with the subtracted value. The aforementioned integer converting operation is carried out on all the invested capital tree cost items in a decreasing order of contribution degrees to the business-by-business invested capital.

When the integer converting operation about the invested capital tree constituent item is completed, the contribution degree after the conversion is divided by a greatest common divisor. A value obtained by the division is set as a coefficient which is to be multiplied by the minimum adjustment width of each invested capital tree cost item.

Information (business constituent item, business-by-business invested capital tree, numeric data, minimum adjustment width, coefficient, etc.) unique to each business are previously stored in a storage area (such as a business portfolio management file) for management of the entire business portfolio.

At this stage, business-by-business invested capitals are once computed, and it is checked whether or not a sum of the computed invested capitals is within a specified investment budget amount. When the capital sum exceeds the budget amount, the apparatus displays an over-budget alarm screen view to prompt the user to resume his operations (for example, to resume operations from the formation of the business portfolio. When the capital amount is within the budget amount, the apparatus shifts to business investment distribution adjusting operation. The business investment distribution adjusting operation is carried out by the investment distribution adjusting program 106 according to a procedure of Steps C916 to C1103.

The investment distributions in all businesses in the business portfolio are computed, and displayed by a pie chart 1201 (investment distribution pie chart) indicative of the computed investment distributions. Each of the investment distributions is found by dividing the business-by-business invested capital of each business by a sum of the business-by-business invested capitals. In this case, on the basis of the numeric data of the invested capital tree cost items of each business as inputs; evaluation index computation, probability simulation, etc. are carried out to compute a computation result before the adjustment of the business investment distributions.

The distribution surface of the pie chart 1201 can be modified by dragging a boundary axis 1203 or dragging an entire pie 1202. When the distribution surface is not modified, the computation result before the adjustment of the business investment distributions is set and displayed as the evaluation result of the business portfolio.

In Step 919, when the distribution surface in the pie chart 1201 is modified, the invested capital of the enlarged business is first adjusted. For the enlarged business, the minimum adjustment width of the invested capital tree constituent items is multiplied by a coefficient computed based on the contribution degree. A value computed by the multiplication is set as the adjustment width of each item in the business. The invested capital of the enlarged business is adjusted by increasing the numeric data in units of the adjustment width set for each business-by-business invested capital tree cost item. On the basis of the numeric data of the invested capital tree constituent items as inputs, an increase in the invested capital of the enlarged business is computed, and the invested capital of the enlarged business is updated. At the same time, the numeric data of the invested capital tree constituent items are also updated.

A decrease in the invested capital of the reduced business, on the other hand, is required to be equal or nearly equal to the increase of the invested capital of the enlarged business. The amount of decrease in one of the invested capital tree constituent items is determined according to a procedure of Steps C1001 to C1016.

First of all, only ones of the invested capital tree constituent items of the reduced business not having a contribution degree of zero to the invested capital are detected for comparison, the minimum adjustment width and the business-by-business invested capital of each business with respect to the detected items are compared in the magnitude of contribution degree, and an item having a maximum contribution degree is detected. An increase in the invested capital of the enlarged business is regarded as a decrease in the invested capital of the reduced business, and a value obtained by multiplying the increase value by the item having the maximum contribution degree is treated as a decrease amount α1 of the invested capital to be influenced and decreased by the item. However, since the minimum adjustment width is required to be specified for each item, the numeric data is required to be decreased so as not to be contradictory to the minimum adjustment width. A decrease amount in each invested capital tree constituent item in the business is found by multiplying the minimum adjustment width by a natural number n. Thus the natural number is required to be set as a specific natural number. By incrementing the natural number for use in the multiplication by 1 from 0, a decrease in the numeric data of the invested capital tree constituent item is computed while a decrease in the invested capital is computed. The decrease of the invested capital tree constituent item, when the decrease of the invested capital computed with the incremented natural number becomes α1 or more for the fist time, is set as a value to be actually decreased. At this time, a value obtained by subtracting the value of the invested capital to be actually decreased from a scheduled decrease amount of the (entire) invested capital is previously saved in an area (variable h).

Next, one of the items having a second-larger contribution degree to the invested capital is detected. A ratio of the contribution degree of the detected item to a sum of contribution degrees of items for the decrease amount not to be computed yet, is computed. By multiplying the computed ratio by the value previously saved in the area (variable h), a decrease amount α2 in the invested capital to be influenced and decreased by the item of interest. By incrementing a natural number for use in the multiplication of the minimum adjustment width of the detected item by 1 from 0, a decrease in the numeric data of the invested capital tree constituent item and a decrease in the invested capital are computed. A decrease in the invested capital tree constituent item when the decrease of the invested capital becomes α2 for the first time, is set as a value to be actually decreased. At this time, the amount of the invested capital to be actually decreased is subtracted from the value previously saved in the area (variable h), and the area (variable h) is updated with the computed value.

In the operations of Steps C1007 and C1011, decreases of the invested capital tree constituent item, when the decrease of the invested capital computed as linked with the incremented natural number becomes more than α1 and α2, are set. However, the decrease of the invested capital tree constituent item, just before the decrease amount computed as linked with the incremented natural number exceeds α1 and α2, may be set. In the latter case, the actual decrease amount of the invested capital becomes less than α1 and α2.

The operations of Steps 1006 to 1009 are executed for the invested capital tree constituent items in a decreasing order of contribution degrees to the business-by-business invested capital. When items have the same contribution degree, however, decreases for all items having the same contribution degree are computed and then the value of the area (viable h) is updated.

Through the procedure of Steps C920 to C1111, numeric data after adjustment of the invested capital tree cost items in the enlarged and reduced businesses are computed. Evaluation index computation or probability simulation is executed with use of the numeric data after the adjustment as inputs.

A sum of business-by-business invested capitals is again computed to check the presence or absence of a remainder (balance) in the total investment budget amount (that is, to check whether or not the total of business-by-business invested capitals is less than the investment budget amount). At this time, if the total business-by-business invested capital is equal to the total budget amount, then the apparatus terminates its operation. If there is a balance, then the apparatus enables addition of another business to the portfolio. A list of businesses not incorporated in the business portfolio is displayed to prompt the user to selectively add a business to the portfolio. Even for the added business, a series of operations, including cost item extraction by sensitivity analysis, invested capital tree definition, the decision of the minimum adjustment width of the invested capital tree constituent items, and the adjustment of a contribution degree to the invested capital, are executed, and the re-evaluation of the entire business portfolio and the re-adjustment of investment distributions, are carried out. The operations of Steps 704 to C1111 are repetitively executed to study the optimum investment distribution.

It should be further understood by those skilled in the art that although the foregoing description has been made on embodiments of the invention, the invention is not limited thereto and various changes and modifications may be made without departing from the spirit of the invention and the scope of the appended claims.

1. A business evaluation supporting method for supporting evaluation of a business portfolio of a plurality of business items, comprising the steps of:
extracting an evaluation index model suitable for a evaluation target of said plurality of business items on the basis of the evaluation target; and
computing an index to evaluate said business portfolio on the basis of the extracted evaluation index model.

2. The business evaluation supporting method according to claim 1, wherein an invested capital amount of a plurality of items is set for each of said business items, a modification of at least one of set invested capital amounts is accepted, and when the accepted modification requires a modification of another invested capital amount, the modification of the other invested capital amount is carried out in a range wherein restriction conditions of the plurality of items of the modification-required invested capital amount are satisfied.

3. The business evaluation supporting method according to claim 2, wherein said restriction conditions include a minimum modification width of each of the items of the invested capital amount.

4. A business evaluation supporting apparatus for supporting evaluation of a value of a business portfolio of a plurality of business items, comprising:
means for storing a plurality of evaluation index models for business evaluation;
means for extracting one of said evaluation index models suitable for an evaluation target of said plurality of business items on the basis of the evaluation target; and
means for computing an index to evaluate said business portfolio on the basis of the extracted evaluation index model.

5. The business evaluation supporting apparatus according to claim 4, further comprising:
means for setting an invested capital amount of a plurality of items for each of the plurality of business items;
means accepting a modification of at least one of the set invested capital amounts; and
when the accepted modification requires a modification of another invested capital amount, means for executing the modification in a arrange wherein restriction conditions of a plurality of items of the modification-required invested capital amount are satisfied.

6. The business evaluation supporting apparatus according to claim 5, wherein said restriction conditions include a minimum modification width of each of the items of the invested capital amount.

7. A recording medium having a program capable of being read by a computer and stored therein, said program supporting evaluation of a value of a business portfolio of a plurality of business items, said program causing said computer to:
extract an evaluation index model suitable for an evaluation target of said plurality of business items on the basis of the evaluation target; and
compute an index for evaluating said business portfolio on the basis of the extracted evaluation index model.

8. The recording medium according to claim 7, wherein said program causes said computer to further:
set an invested capital amount of a plurality of items for each of the plurality of business items;
accept a modification of at least one of the set invested capital amounts; and
when the accepted modification requires a modification of another invested capital amount, execute the modification in a range wherein restriction conditions of a plurality of items of the modification-required invested capital amount are satisfied.

9. The recording medium according to claim 8, wherein said restriction conditions include a minimum modification width of each of the items of the invested capital amount.
